(19) United States
(12) Patent Application Publication
(10) Pub. No.: US 2019/0080413 A1
(43) Pub. Date: Mar. 14, 2019

(54) SYSTEM AND METHOD FOR PLANNING AND ALLOCATING CAPITAL

(71) Applicant: Windom Peak Corporation, Spring, TX (US)

(72) Inventor: Larry Gregg Chorn, Golden, CO (US)

(21) Appl. No.: 16/052,272

(22) Filed: Aug. 1, 2018

Related U.S. Application Data
(60) Provisional application No. 62/542,151, filed on Aug. 7, 2017.

(51) Int. Cl. G06Q 40/06; G06Q 10/06; G06F 3/0482

(52) U.S. Cl. CPC G06Q 40/06; G06F 3/0482; G06Q 10/06375; G06Q 10/067

(57) ABSTRACT

A method includes receiving an indication of a company goal representing a multi-year financial goal. The method also includes determining multiple feasible capital projects for achieving the company goal, the multiple feasible capital projects based on a set of investment opportunity and planning scenarios. The method also includes receiving a user selection of multiple capital projects among the multiple feasible capital projects. The method also includes determining at least one route for each of the selected capital projects, wherein each route indicates a contribution, by the selected capital project, of progress toward the company goal. The method also includes generating a graphical display showing a mountain, wherein the company goal is visually represented as a summit of the mountain and the routes are visually represented on one or more sides of the mountain.

### CROSS-REFERENCE TO RELATED APPLICATION AND PRIORITY CLAIM

This application claims priority under 35 U.S.C. § 119(e) to U.S. Provisional Patent Application No. 62/542,151, which was filed on Aug. 7, 2017. This provisional application is hereby incorporated by reference in its entirety.

### TECHNICAL FIELD

This disclosure is generally directed to a system and method for planning and allocating capital.

### BACKGROUND

Planning and allocation of capital are important activities in large and small organizations across a wide spectrum of industries. In many cases, long term, high dollar, irreversible investment decisions must be made to ensure success in an organization. However, tools that facilitate this process lack key decision making features.

### SUMMARY

This disclosure describes a system and process for leading a capital planning and senior management team in the capital allocation process. As described in this document, embodiments of this disclosure address capital planning in the oil and gas upstream industry and use a mountain climbing analogy to visualize the process. Other industries in which the disclosed embodiments are applicable include pharmaceuticals, conglomerate heavy industries, basic and specialty chemical manufacturing, R&D and multi-product industries like food and beverage manufacturing, and the like. The analogy of mountain climbing is used to explain the path to a goal or an achievement. Analogies other than mountain climbing could be a marathon, a bicycle race, ocean racing or any stressful event that takes a participant from point A to point B and requires the participant to overcome adversity and uncertainty.

In a first embodiment, a method includes receiving an indication of a company goal representing a multi-year financial goal. The method also includes determining multiple feasible capital projects for achieving the company goal, the multiple feasible capital projects based on a set of investment opportunity and planning scenarios. The method also includes receiving a user selection of multiple capital projects among the multiple feasible capital projects. The method also includes determining at least one route for each of the selected capital projects, wherein each route indicates a contribution, by the selected capital project, of progress toward the company goal. The method also includes generating a graphical display showing a mountain, wherein the company goal is visually represented as a summit of the mountain and the routes are visually represented on one or more sides of the mountain.

In a second embodiment, a system includes at least one memory and at least one processor coupled to the at least one memory. The at least one processor is configured to receive an indication of a company goal representing a multi-year financial goal; determine multiple feasible capital projects for achieving the company goal, the multiple feasible capital projects based on a set of investment opportunity and planning scenarios; receive a user selection of multiple capital projects among the multiple feasible capital projects; determine at least one route for each of the selected capital projects, wherein each route indicates a contribution, by the selected capital project, of progress toward the company goal; and generate a graphical display showing a mountain, wherein the company goal is visually represented as a summit of the mountain and the routes are visually represented on one or more sides of the mountain.

In a third embodiment, a non-transitory computer readable medium contains instructions that when executed cause at least one processing device to receive an indication of a company goal representing a multi-year financial goal; determine multiple feasible capital projects for achieving the company goal, the multiple feasible capital projects based on a set of investment opportunity and planning scenarios; receive a user selection of multiple capital projects among the multiple feasible capital projects; determine at least one route for each of the selected capital projects, wherein each route indicates a contribution, by the selected capital project, of progress toward the company goal; and generate a graphical display showing a mountain, wherein the company goal is visually represented as a summit of the mountain and the routes are visually represented on one or more sides of the mountain.

Other technical features may be readily apparent to one skilled in the art from the following figures, descriptions, and claims.

### BRIEF DESCRIPTION OF THE DRAWINGS

For a more complete understanding of this disclosure and its features, reference is now made to the following description, taken in conjunction with the accompanying drawings, in which:

FIG. 1 illustrates an example screen image of a Climb Status page that may be displayed by an application according to this disclosure;

FIGS. 2A, 2B, and 3 illustrate block diagrams showing example data flows through the GUIDE application process, according to this disclosure;

FIG. 4 illustrates a workflow diagram showing example tasks that are called by GUIDE according to this disclosure;

FIG. 5 illustrates a block diagram showing various tasks performed in the KNAPSACK routine, according to this disclosure;

FIG. 6 illustrates a workflow diagram showing an example of the KNAPSACK routine when called by GUIDE, according to this disclosure;

FIG. 7 illustrates a workflow diagram showing an example of the TASK MONITOR routine, according to this disclosure;

FIG. 8 illustrates a workflow diagram showing an example of the BASE CAMP 1 routine, according to this disclosure;

FIGS. 9A and 9B illustrate workflow diagrams showing examples of the MESH routine, according to this disclosure;

FIG. 9C illustrates a screen image showing graphics with mountain contours converted to a x-y-z mesh for visualization of a climb route

FIG. 10 illustrates a workflow diagram showing an example of the DRONE routine, according to this disclosure;

FIG. 11 illustrates a workflow diagram showing an example of the PITCH (n) routine, according to this disclosure;

FIG. 12 illustrates a workflow diagram showing an example of the SCOUT routine, according to this disclosure;

FIGS. 13A and 13B illustrate workflow diagrams showing examples of the SCRAMBLE routine, according to this disclosure;

FIGS. 14A through 14C illustrate workflow diagrams showing examples of the CLIMBER routine, according to this disclosure;

FIG. 15 illustrates a workflow diagram showing an example of the WHAT-IF routine, according to this disclosure;

FIG. 16 illustrates a workflow diagram showing an example of the OXYGEN routine, according to this disclosure;

FIG. 17 illustrates a workflow diagram showing an example of the ACROPHOBIA routine, according to this disclosure;

FIG. 18 illustrates a workflow diagram showing an example of the ALTITUDE routine, according to this disclosure;

FIG. 19 illustrates a workflow diagram showing an example of the VISIBILITY routine, according to this disclosure;

FIG. 20 illustrates a workflow diagram showing an example of the WEATHER routine, according to this disclosure;

FIG. 21 illustrates an example system for planning and allocating capital, according to this disclosure; and

FIG. 22 illustrates an example of a computing device for planning and allocating capital, according to this disclosure.

### DETAILED DESCRIPTION

The figures discussed below and the various embodiments used to describe the principles of the present invention in this patent document are by way of illustration only and should not be construed in any way to limit the scope of this disclosure. Those skilled in the art will understand that the principles of the present invention may be implemented in any type of suitably arranged device or system.

For simplicity and clarity, some features and components are not explicitly shown in every figure, including those illustrated in connection with other figures. It will be understood that all features illustrated in the figures may be employed in any of the embodiments described. Omission of a feature or component from a particular figure is for purposes of simplicity and clarity and is not meant to imply that the feature or component cannot be employed in the embodiments described in connection with that figure.

It will be understood that embodiments of this disclosure may include any one, more than one, or all of the features described here. Also, embodiments of this disclosure may additionally or alternatively include other features not listed here. While the disclosed embodiments may be described with respect to capital planning in the oil and gas upstream industry, these embodiments are also applicable in any other suitable applications or industries.

As noted above, the disclosed embodiments address capital planning in the oil and gas upstream industry and use a mountain climbing analogy to visualize the process. In some embodiments, the disclosed embodiments provide a computer application that allows a user to perform the capital planning using the mountain climbing analogy. Using the application, the user can assemble a set of incremental new capital projects to purchase (each reflected as step on a route up the mountain) that when combined fits a company's multi-year financial goal (i.e., the summit). The mountain shape is digitally generated in the application to simulate a company's capital projects. For example, the mountain shape can be rugged if the company's projects are risky (i.e., likely to fail), to reflect the possibility of falling, or smooth and continuous (an easy climb up a beaten trail, for example) if the projects are not risky. In some cases, the mountain shape can be a mixture of rugged and smooth terrain.

In some embodiments, the mountain includes one peak, or summit, that represents an overall company or corporate goal in a future year, X. One or more valleys (steep rugged areas) are randomly distributed around the mountain to reflect difficult climbing. For example, an input of a risky project into the application could generate a route across a steep, rugged area on the way to the summit.

Each project input into the application contributes to achieving the corporate goal (i.e., production rate, cash flow, profitability, etc.). Selecting (or buying) a project moves the company closer to the goal, the summit. The application considers the project “riskiness” (chance of not achieving target metrics), looks at how much higher on the mountain, from the present location to the summit, is achieved with the new project and picks a new portfolio location (including the new project) on the mountain. The riskiness dictates whether the path to that new location crosses smooth, easy mountain terrain or goes through a steep, “dangerous” area. The application also allows a user to move downwards on the mountainside (away from the goal) by picking a project that dilutes or reduces the portfolio's goal metrics.

The following can serve as an example. A corporation seeks $1 billion annual profit by year X. Today it is at $750 million. Thus, $250 million in additional profit is desired. Additional attractive projects add profits. A project that adds $25 million by year X will move the portfolio location, in the year the project is funded, up the mountain by 10% ($25 million is 10% of $250 million) of the distance (elevation) between the existing portfolio, before new project is funded, and the summit. Thus, if the distance between the existing portfolio and the summit is 2500 ft., the project would result in a 250 ft. elevation gain.

The disclosed embodiments provide a user with a visually clear, easily understandable, and more interesting representation of the projects and goals without overloading the user with many tables of numbers that are not quickly comprehended. This allows the user to make decisions more effectively and easily. Also, unlike conventional tools that execute routines in a “black box” and output a single optimized corporate metric or portfolio, the disclosed embodiments are interactive and allow the user to customize and experiment before (and after) a portfolio is generated.

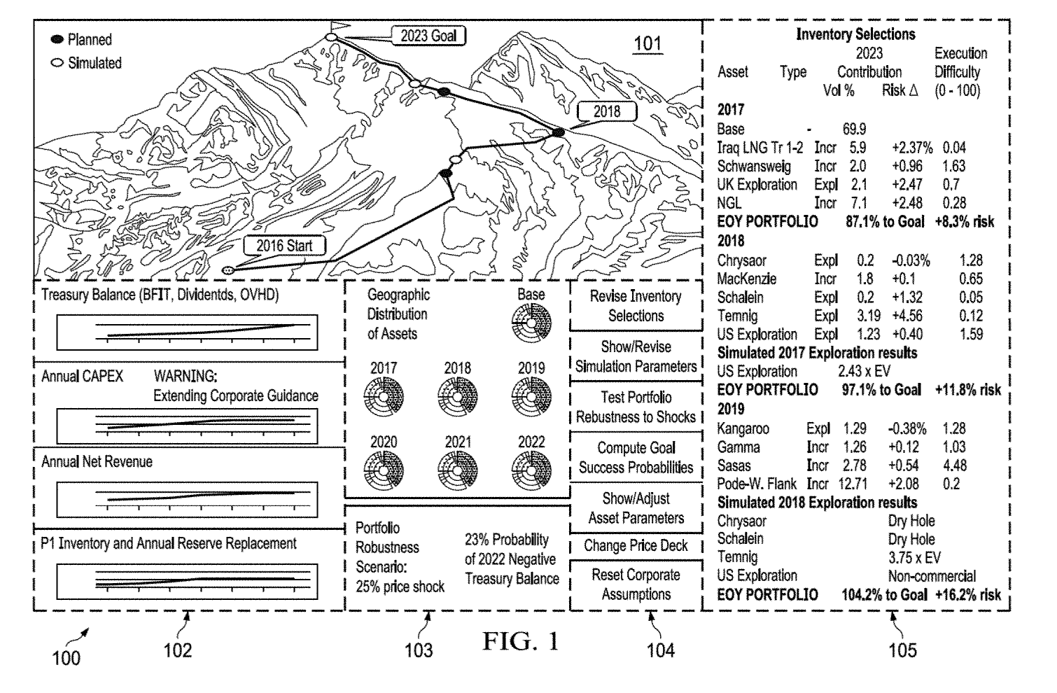

FIG. 1 illustrates an example screen image of a Climb Status page 100 that may be displayed by the application according to this disclosure. The Climb Status page 100 is a “dashboard” for the overall operation of the application. The Climb Status page 100 displays a mountain graphic 101 and information 102-105 that show the user how well the user's selections are contributing to goal achievement. The graphic 101 shows the mountain with a summit or goal and a start point, or “base camp.” Base camp is the company's existing set of ongoing funded projects. Base camp contains the aggregated metrics of those projects, and its location on the mountain is determined, in the application, by how far from the corporate goals it is (elevation) and how risky the aggregate project set is (located in a steep area or a flat area on the mountain side).

The information 102 can include one or more corporate metrics, remaining budget to be spent by year, fixed costs incurred for the aggregate portfolio, income before taxes, etc. by year. The information 103 shows “types” of assets selected and riskiness of the route to the summit, i.e., the likelihood of achieving the goal within the time frame with the projects selected. User controls 104 (e.g., buttons) allow the user to invoke changes in project selection, test for disruptive events (e.g., price shock), change product price assumptions, and the like. The information 105 shows selections of inventory by year.

The following sections document how the user navigates through the application and achieves a customized investment goal. In the following discussion, GUIDE is used as the name of the overall management application that interacts with the user and calls other routines to execute the user's intent at each stage. GUIDE manages data, interface, and execution algorithms. GUIDE monitors user requests, call application routines in response, manages input/output data, and the like. If a user actuates a control (e.g., pushes a button) on the Climb Status page 100, GUIDE responds with a call to an appropriate subroutine to address the request.

While the following embodiments are described with respect to one user, this is merely one option, and the disclosure is not limited to one user. In some embodiments, multiple users can collaborate in a real-time interactive manner to develop and test goals and projects. For example, the application can be projected onto a conference room screen for several users to see and discuss. Each user may have a corresponding user device (e.g., a touchpad, laptop, workbook, etc.) that interacts with the other user devices and the application and allows each user to “drill down” on a particular project, query the database of possible projects, test alternatives to the existing portfolio, and the like.

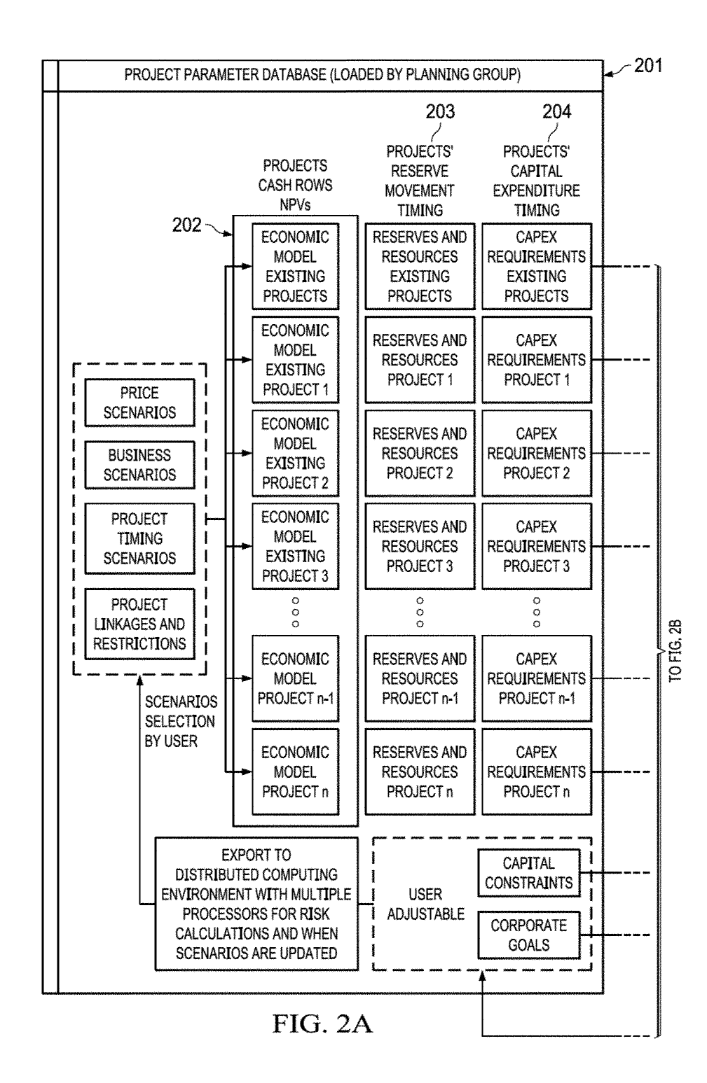

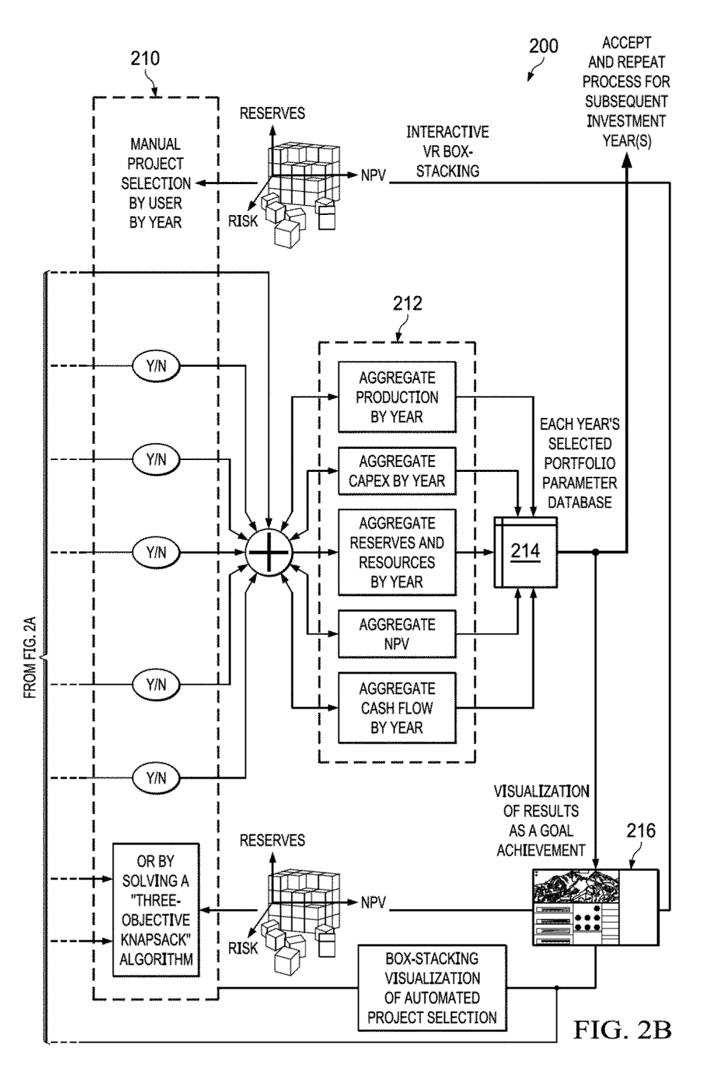

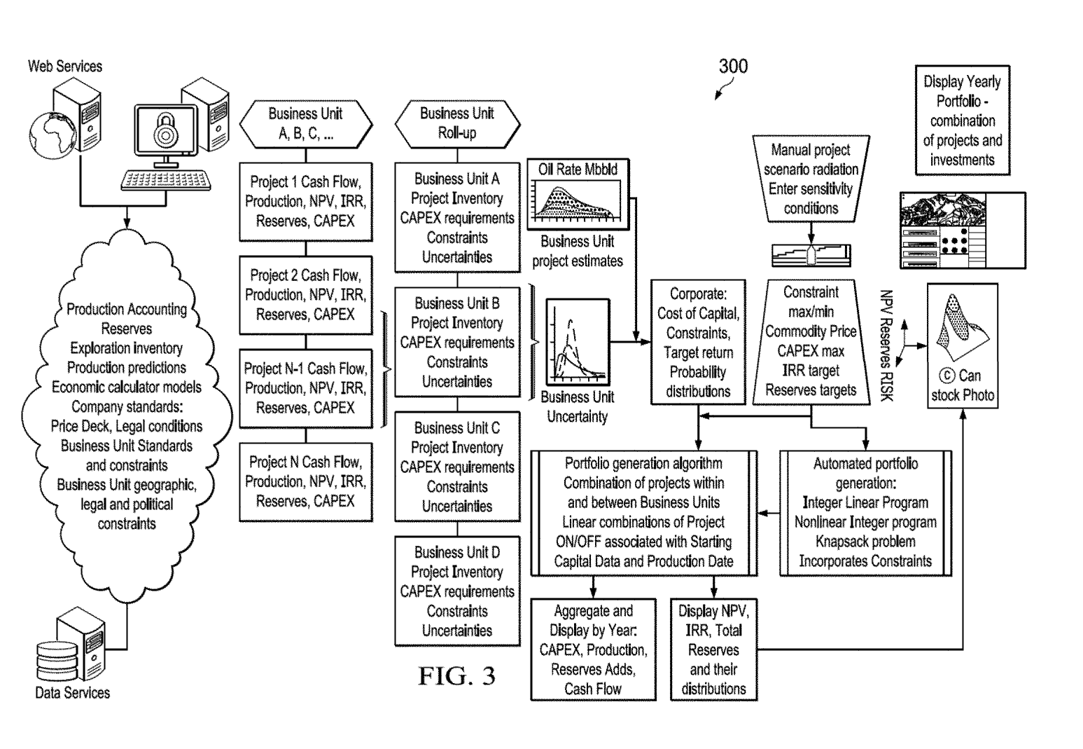

FIGS. 2A, 2B, and 3 illustrate block diagrams 200, 300 showing example data flows through the GUIDE application process, according to this disclosure. Specifically, FIGS. 2A and 2B illustrate a detailed block diagram 200 of the GUIDE application process, and FIG. 3 illustrates a block diagram 300 showing additional details of the GUIDE application process.

As shown in FIGS. 2A and 2B, the block diagram 200 includes a database 201 that stores project parameters used in the application. The database 201 includes corporate level information as well as individual project information 202. The project information 202 includes existing projects that the company already owns and other feasible capital projects (identified as “Project 1”, “Project 2”, etc.) that the company could select and fund (with an existing budget) in order to try to meet its goals. The projects include economic model information (e.g., project cash flows, revenues, fixed and variable costs, and the like), which may be summarized as one or a handful of overall numbers, such as net present value. The Project Reserve Movement Timing information 203 includes reserve information for each project and can include SEC-defined reserve and resource categories such as proven, probable, and possible. The Project Capital Expenditure Timing information 204 tracks requirements for expenditures of capital over a period of time (e.g., dollars required to be spent each year in years 2, 3, 4, etc.).

A manual project selection 210 represents user controls (buttons, check boxes, or the like) on the display of the application that allow the user to select or de-select one or more feasible projects by year (e.g., Year 1, Year 2, etc.). That is, the user can select a first set of projects for Year 1, a second set of projects for Year 2, and so on. Each set of selected projects is incremental to the existing project portfolio. Once the projects are selected, the application computes multiple aggregate values 212, including aggregate production by year, aggregate CAPEX by year, aggregate reserves and resources by year, aggregate NPV of the portfolio, and aggregate cash flow by year. The projects are then added to each year's selected portfolio parameter database, and the information is used to generate the base camp, as discussed in greater detail below. A visualization 216 of the results of the projects is presented in the mountain analogy (such as shown in FIG. 1) in order to show progress towards achievement of the goal.

In one aspect of operation, the following tasks are performed by the GUIDE application.

1. Launch the graphical user interface (GUI), establish data links, and determine user intent. Here, user intent refers to what the user wants to do next in the application. An example of user intent is the following: “I want to continue my project selection for year 2 now. I had to go to a meeting and saved my year 1 selections and am ready to proceed with year 2. Please open the database that was saved before my meeting so I can add to those year 1 selections.”

2. Configure the application according to user intent. Acquire database access or generate new database. Schedule tasks according to user intent and the ‘climb’ status—a decision tree to identify new tasks in sequence. Test prior tasks' completion status, validity and consistency. Show task list/status/recommended actions.

3. Manage task algorithms, including:
Opportunity data loading
Corporate guidelines/parameters/number of budget cycles to consider
Opportunity reserves and resources
Opportunity correlations and constraints
Mountain mesh points
Base camp portfolio elements
Base camp evolution (depletion of reserves) through the # of budget cycles under consideration
Goal metrics
Scenario descriptions—effects on each Opportunity
User-customized algorithms and their applications.

The user can customize the described algorithms in multiple ways. For example, the user may want to closely track cash flow in the first year. In such a case, the user could choose to use a West Texas Intermediate oil price forward curve as the price deck in year one and switch to a flat price deck in years 2, 3, and so on. Then the user would require the application to use a 12 month forward curve for the first 12 months and switch to a flat price scenario afterwards.

The following tasks are driven by the user and executed with the GUIDE application:

1. Group opportunities by type: altitude gain, risk, initial CAPEX, total CAPEX, OPEX, durability, hypothetical, reserves, exploration, and the like.

2. Review opportunities (What opportunities are in the pipeline? What are the characteristics of each opportunity? Did the opportunity load correctly in the database from the user's economic model? Is the present loaded representation still correct and appropriate? If not, the user can change the representation.)

3. Define goal (one or more business metrics): User algorithm, Feasibility test, Revision (Y/N). Some representative examples of goals include increasing proven reserves by 20 percent, increasing annual cash flow by $1 billion, and decreasing cost of finding and developing by 10 percent. An example feasibility test might be whether there are sufficient positive NPV projects in the opportunity inventory to achieve the stated goal or checking whether the timing of a project's start-up date is beyond the planning horizon.

4. Create constraints for each opportunity: correlated opportunities, selection and timing restrictions, ‘must do’ opportunities, and A&D of existing opportunities—(Y/N), fraction ownership, timing, valuation.

5. Design scenarios (base, upside (good weather), downside (stormy weather)) and what economic and geopolitical parameters are reflected in each. As used herein, a scenario refers to state of business conditions in the future (within the time window). A BASE scenario would be what the company thought would occur. An UPSIDE scenario could include better prices, higher demand, lower regulation, etc. For the mountain analogy described herein and shown in FIG. 1, this would be reflected as good climbing weather (sunny and dry). A DOWNSIDE scenario could include poor prices (i.e., a falling price environment), poor economic conditions overall, poor project execution, or rising regulatory challenges. For the mountain analogy described herein, this could be represented as an unexpected snow storm. The user can create scenario details for the project. For example, one scenario might describe how much oil and gas prices will go up and when.

6. Load Base Camp on mountain mesh; scale contours according to % goal achievement; compute routes (low risk, high risk, emphasizing opportunity type, lowest cost, irrespective of cost, user selected type). Save for inspection. Use base scenario for this task and P50 (most likely) for what-ifs; no A&D. (As known in the art, P50 represents the most likely outcome in an uncertain future. For example, if oil prices are expected to be between $80 and $40 per barrel, and are most likely expected to be $65, then $65 is the P50 value in the probability distribution of price in the future.) If goal achievement is not feasible, then generate the route with best result within corporate constraints and report shortfall metrics. On the other hand, if hypothetical opportunities exist, compute the Ps (probability of success) for each; that is, execute “drill down routine” to compile what opportunities are chosen for the route selected and corporate metrics at each budget cycle end. Herein, the “drill down routine” is as follows: Once the user has selected a year's worth of projects to fund, s/he can request the application to compute and display the contribution of each project to the overall goal achievement. This can include a check on how the portfolio and the corporation are performing at that year's end (e.g., Are you within budget? Do you have a positive balance in the treasury?).

7. Application displays mountain base camp, computed routes, opportunity selections, and corporate metrics in the GUI, and shows any violations of policy or strategy. The user can see the lowest cost route and is presented with a route menu to choose from. The user can choose any of these routes and convert to a “final” route designation, testing for robustness and probability of goal achievement. The user can choose to return to base camp and begin the climb if all pre-climb tasks are complete, or return to any pre-climb task and edit parameters, including goal and hypotheticals, and including A&D opportunities and exploration.

The following represents user-driven operations that may be performed during a climb execution (e.g., a climb to a next location on the mountain (e.g., end of a capital budgeting cycle)):

1. Choose opportunities to fund from a menu of opportunities, or accept selections from any computed route.

2. Dynamic meters (gauges) shown to user; track by year forward:
P1, P2, P3 reserve adds and resources, if an exploration opportunity (exploration only adds resource oil and gas volumes; development adds reserve volumes leading to production)
CAPEX committed by year and remaining treasury balance available
Production wedge acquired
OPEX committed by year
Gross/net revenue wedge
Fraction to goal (summit of mountain)
NPV wedge
Any linked opportunities now available or no longer available and any now required

As known in the art, oil and gas companies categorize their in-ground reserves according to the risk of being able to produce them as well as whether or not they are developed and producing, awaiting investment or awaiting a technology development. P1, P2 and P3 refer to proven, probable and possible reserve categories, respectively. The higher the number the riskier (and less likely to be monetized) they are.

As used herein, a “wedge” can be explained as follows: Visualize that each year a project contributes cash flow, production volumes, and new reserves, as well as fixed and variable costs. The aggregate portfolio has a profile for each of these metrics as a function of time. When incremental projects are added to the portfolio, they add (or delete) from the existing profile each year. These adds/deletions are called wedges.

3. Constraints for present budget year are shown with progress, including remaining CAPEX, number of opportunities allowed in year, free rigs, and the like.

4. Opportunities that are no longer fundable due to CAPEX balance are no longer selectable from the menu of opportunities.

5. The user continues selecting opportunities until a present budget year constraint is hit OR the user selects END of selection for year. Hitting a limit triggers an alert to the user. The user can then do one of the following: (i) the user can stop and proceed to ‘status check’; (ii) the user can go back and de-select; or (iii) the user can save and exit the climb routine and exit application OR edit pre-climb tasks (return to base camp).

6. Choosing ‘status check’ moves control back to GUIDE where an auto-execution process begins:

6.1. First year opportunities' economics and reserves/resources are stored in a temporary database for use in other tasks.

6.2. Base portfolio economics are updated to new year-end and stored in the temporary database.

6.3. Aggregate portfolio metrics and forward profiles are computed and stored.

6.4. Reserve replacement for year is computed.

6.5. Corporate metrics are computed for year-end.

6.6. Climb feasibility is recomputed and probability of success is computed for the first time.

6.7. All results are saved and stored in the temporary database

6.8. User chooses to perform at least one of the following (6.8.a.-6.8.d):

6.8.a. Continue climb through next stage (capital budgeting year).

6.8.b. Exit and save progress indicator.

6.8.c. Compute robustness of portfolio to:
6.8.c.i. Base uncertainty of projects, or

6.8.c.ii. Robustness to another scenario, or

6.8.c.iii. Both 6.8.c.i and 6.8.c.ii.

6.8.d. Post-robustness test, the user may choose to:
6.8.d.i. Return to base camp and make new selections (replacing any or all), or

6.8.d.ii. Return to base camp and return to pre-climb tasks, including one or more of the following: (i) Add capital, (ii) Add exploration or acquisition opportunities, (iii) Relax any other corporate constraints, (iv) Change scenario parameters, and (v) Exit (to rethink process).

6.9. The following are performed based on the user's choice in 6.8:
6.9.a. If the user chooses 6.8.a., then begin selections for second year.

6.9.b. If the user chooses 6.8.b., then the application closes (exits) and successfully stores all results.

6.9.c. If the user chooses 6.8.c.i., then the application starts year 1 again fresh.

6.9.d. If the user chooses 6.8.c.ii., then the application updates edits in the temporary database, revisits any pre-climb tasks as required, and begins climb execution again at base camp.

6.9.e. If the user chooses 6.8.c.iii., the application exits successfully.

6.10. If the user chooses 6.8.a. and completes next stage (e.g., 2nd, 3rd, 4th capital budgeting year), then a status check is executed, the results are stored, and the user then repeats the 6.8.a-6.8.d sequence. However, if the current year is the last year of the climb then the following occur:
6.10.a. Portfolio (aggregate) results are compared to goals(s), and the user is congratulated if successful. The user may try “what-ifs” after aggregate tasks in 6.10.a. (i.e., turn on or off opportunity selections to see impact on results). Step 6.10.a. is run again for each “what-if”.

6.10.b. Aggregate portfolio probabilistics computed for each year (possible shortfalls (reserve replacements, CF, etc.) noted. This requires a Monte Carlo engine, base and selection economic models, corporate balance sheets, metrics algorithms plus exploration algorithms, and A&D distributions for reserves, production, and price/BOE. A user can choose to (i) save and exit, (ii) save and display ‘final’ results, (iii) export results to a spreadsheet (such as EXCEL), or (iv) make reports (e.g., PDFs) of results.

As known in the art, a Monte Carlo engine is a software algorithm that generates input values to other algorithms, like an economic calculation. It is employed when the user only has a range of possible values for the input. There can be one or more uncertain variables in an economic calculation so a Monte Carlo algorithm is used to generate a value for each uncertain input. The economic calculation is often run thousands of times with different combinations of uncertain input variables to generate a probability distribution for the result. The most likely value is used as the P50 number and the standard deviation of the distribution is a measure of the uncertainty, or riskiness of the estimate.

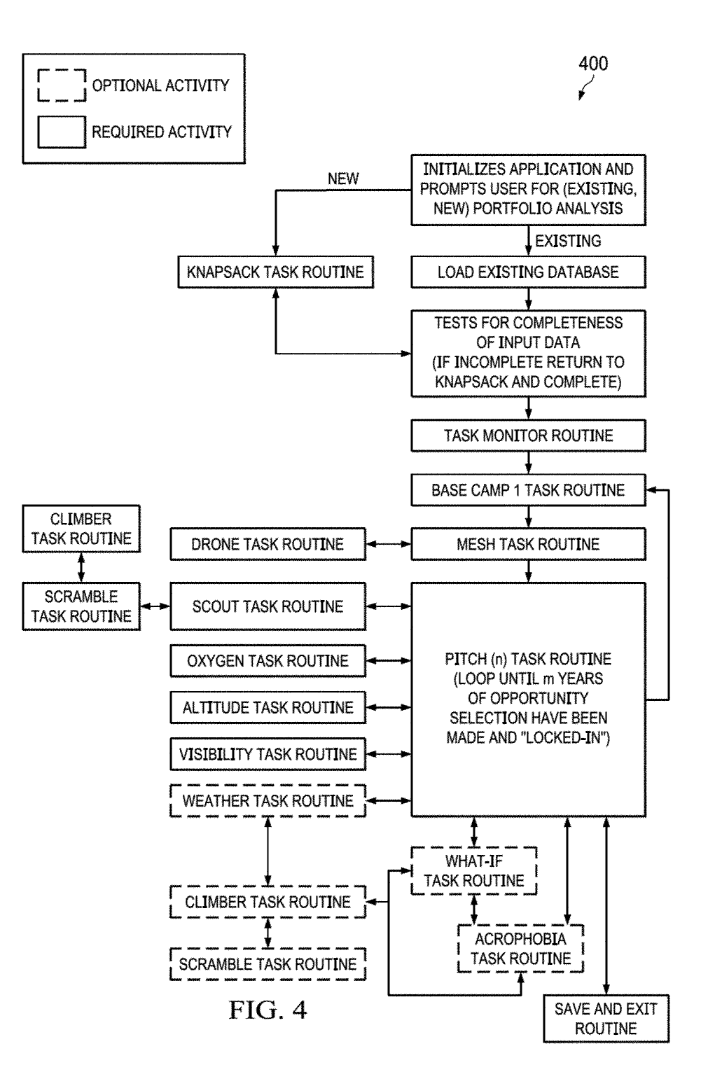

FIG. 4 illustrates a workflow diagram 400 showing example tasks that are called by GUIDE according to this disclosure. As shown in FIG. 4 (and as described above with respect to FIGS. 2A, 2B, and 3), GUIDE generates and monitors windows of the GUI and executes background and user-initiated tasks. In addition, GUIDE manages updates to the GUI windows and presents results depending upon the progress of the user through the application.

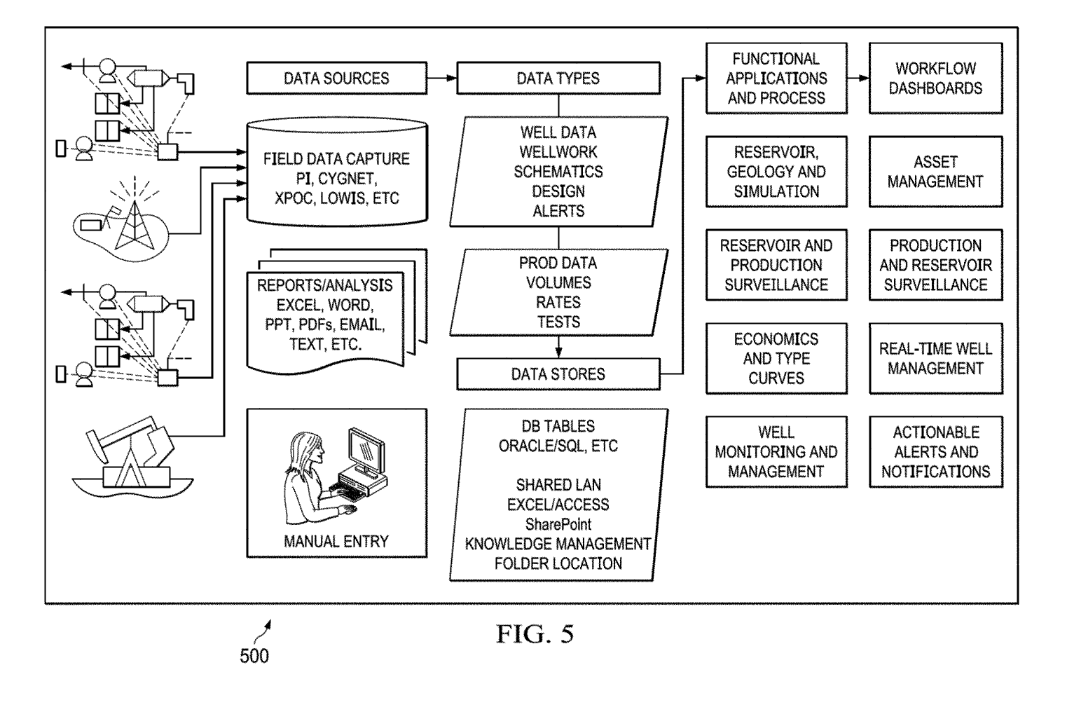

FIG. 5 illustrates a block diagram 500 showing various tasks performed in the KNAPSACK routine, according to this disclosure.

KNAPSACK is a data loading and data management routine that extracts data from one or more economic applications (e.g., PEEP by Schlumberger, ARIES by Halliburton, OGRE, an EXCEL spreadsheets, text files, and the like) and loads the data into the application's database in the proper format for use by the various modules and routines disclosed herein. KNAPSACK catalogs uncertain variables, distributions, and parameters in the economic models. KNAPSACK also captures the user's selection of distribution to represent each uncertain variable, the distribution parameters and any cross-correlations between uncertain variables. Also, KNAPSACK allows a user (e.g., a system administrator) to load corporate guidelines (rules, constraints, restrictions, economic metrics, goals, macroeconomic events, etc.) that are used within the application for calculations and display of results. With KNAPSACK, the user can also load ranges and distributions of possible values for uncertain variables such as discoveries, commodity price, project duration, project costs, reserve size, etc.). These ranges and distributions can be used by the application to develop probabilistic outcomes for the portfolio and to estimate probability of goal achievements. This enables management to set achievable goals given existing opportunities and planning scenarios. In addition, KNAPSACK prompts the user to load details of projects other than the economic inputs, like reserves, “must do” opportunities, opportunity constraints and opportunity linkages.

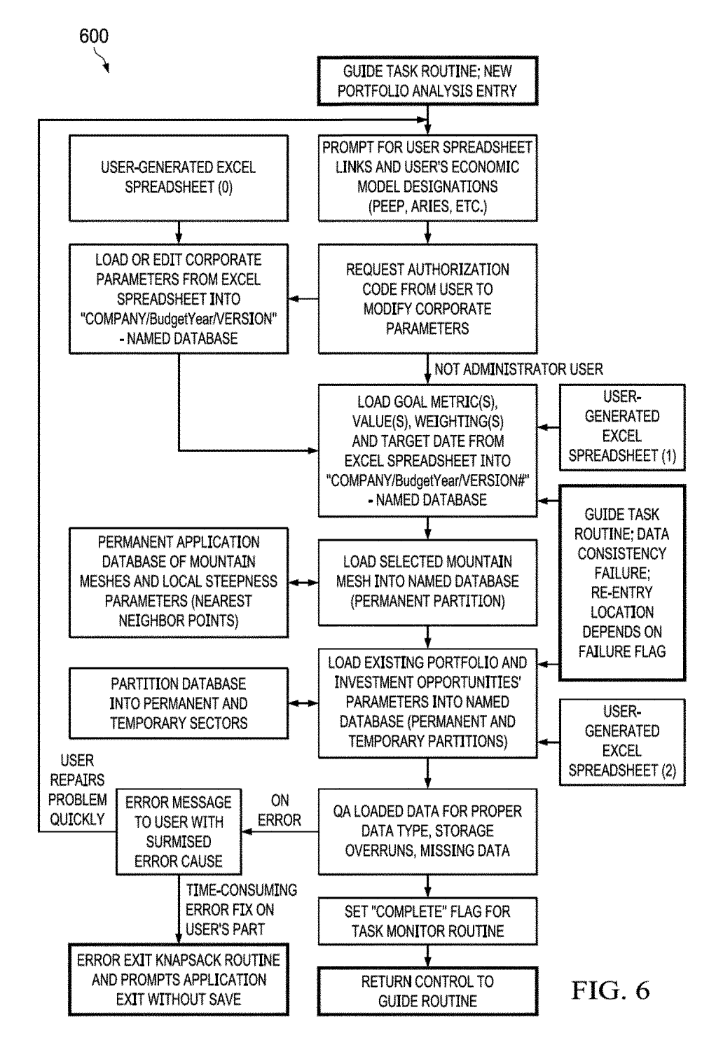

FIG. 6 illustrates a workflow diagram 600 showing an example of the KNAPSACK routine when called by GUIDE, according to this disclosure. Once KNAPSACK completes execution, GUIDE checks for inconsistencies in the data. Errors can be made in the loading or the keying in of data. For example, there might be 55 projects to select from and only 54 economic models loaded. Or a start date in one element of the database for Project 42 might be 2019 and in another place be 2020. GUIDE checks for these mistakes/inconsistencies. If GUIDE detects a data inconsistency upon KNAPSACK's completion, GUIDE calls KNAPSACK and enters the routine at a point where the data inconsistency was detected and generates prompts to the user to repair the data load.

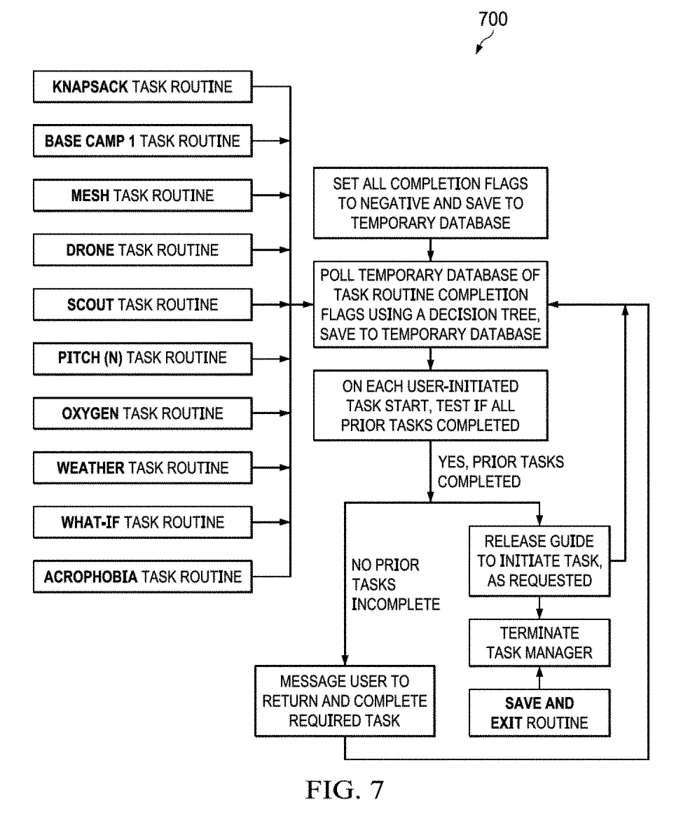

FIG. 7 illustrates a workflow diagram 700 showing an example of the TASK MONITOR routine, according to this disclosure.

TASK MONITOR controls the user's ability to execute tasks until all prior tasks are complete. For example, if the user tries to initiate the PITCH (n) routine (discussed below) before completing BASE CAMP 1 (discussed below), TASK MONITOR can generate a warning message to the user to complete the prior task(s). Completion flags are stored in the temporary database to allow the user to quit the application and return to the point at which he completed tasks and continue from there.

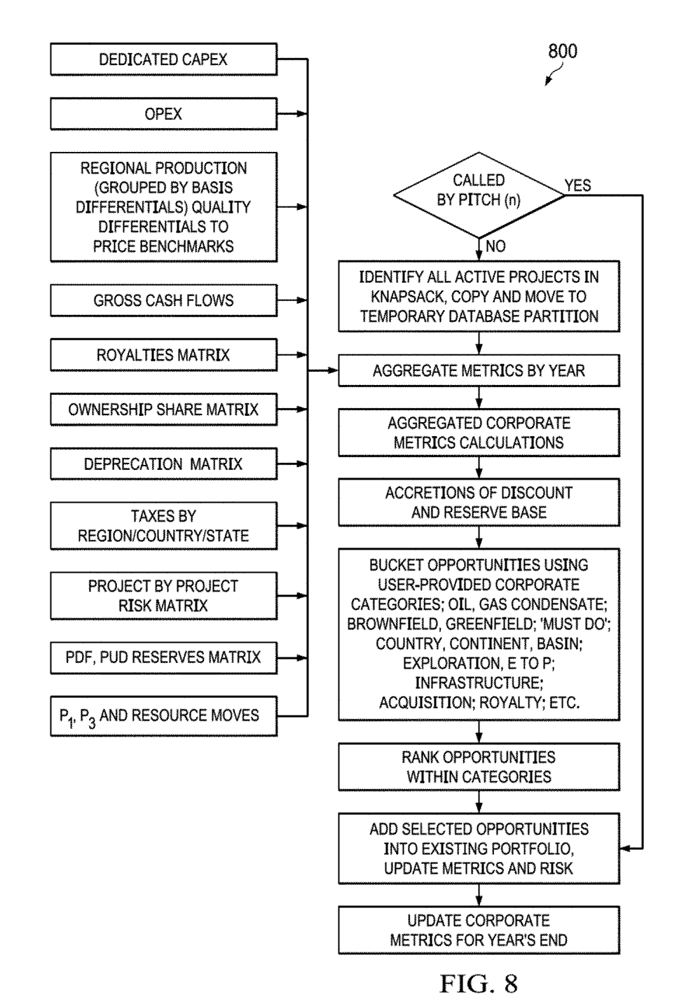

FIG. 8 illustrates a workflow diagram 800 showing an example of the BASE CAMP 1 routine, according to this disclosure.

BASE CAMP 1 is the routine that aggregates all the existing portfolio's projects and their metrics. The existing portfolio is the starting point for the climb, but as time passes its elevation “slides down the mountain” due to production from the existing projects. In many industries, such as the oil and gas industry, projects age and wind down. For example, production rates can fall, cash flow can diminish, cost can go up, etc. Thus, a company may want to continually replace the depleting projects with new ones. If new projects are not added, then the BASE CAMP “slides down the mountain,” i.e., loses elevation and gets further away from the company's future goals. BASE CAMP 1 tracks movements of P2 and P3 reserves within existing projects, tracks the present year's actual and future year's projected cash flows, tracks OPEX required to maintain the existing projects, and tracks allocated CAPEX demands.

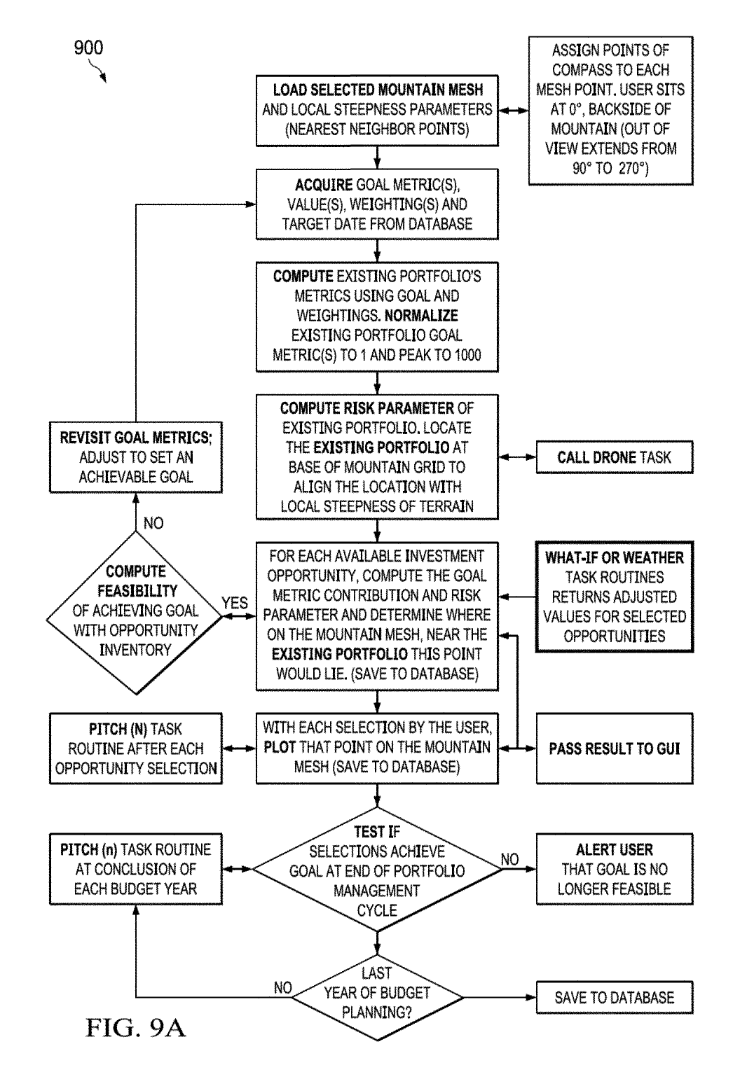

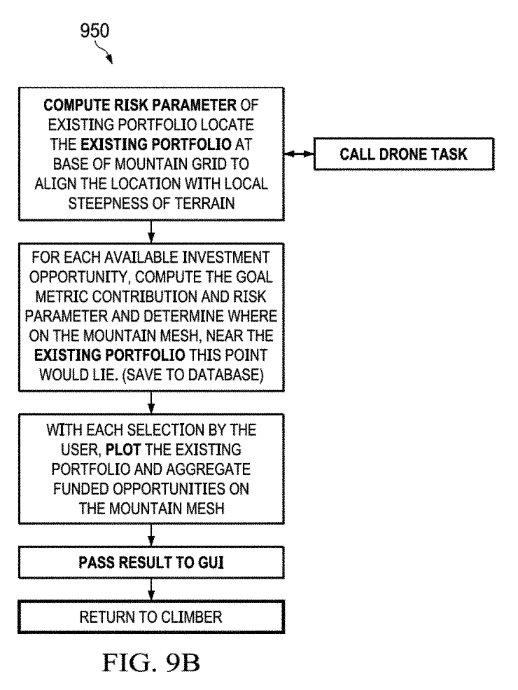

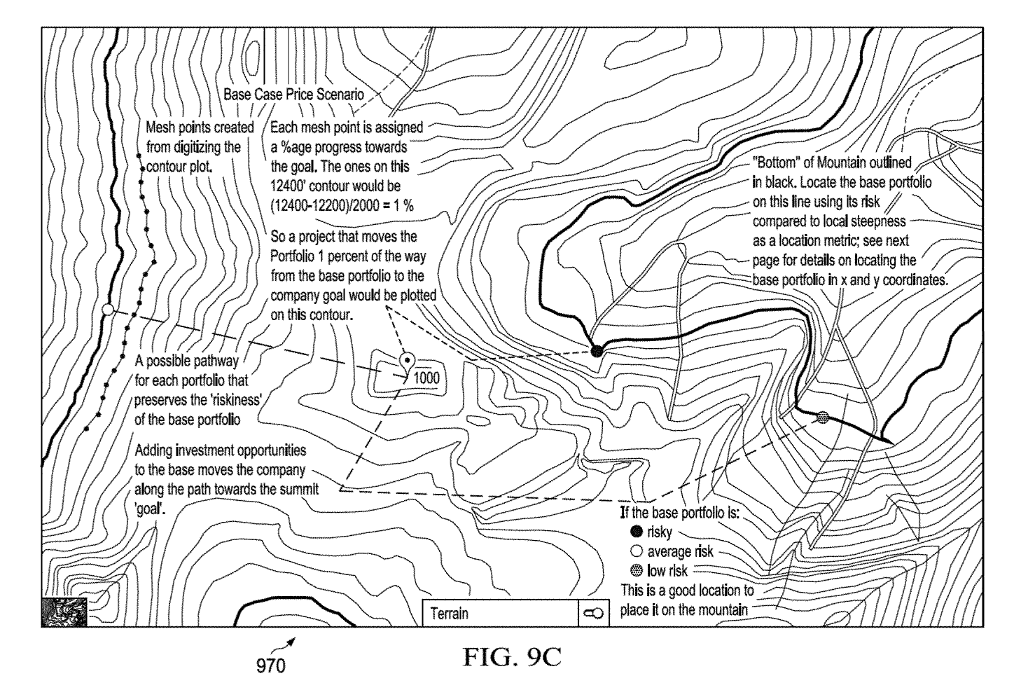

FIG. 9A illustrates a workflow diagram 900 showing an example of the MESH routine when called by GUIDE, according to this disclosure. FIG. 9B illustrates a workflow diagram 950 showing an example of the MESH routine when called by CLIMBER (discussed below), according to this disclosure.

MESH is a routine that loads the mountain mesh from the application database (see FIG. 5) and normalizes the elevation gains to the Goal metric. MESH locates the initial base portfolio on the mountain mesh by aligning the initial portfolio economic risk with local steepness metrics on the mesh. MESH updates the mountain graphic on the GUI window with the base camp location and updates the climbing route as the user makes selections and completes each annual budget cycle using a call from the PITCH (n) routine. FIG. 9C illustrates a screen image 970 showing graphics with mountain contours converted to a three-dimensional (x-y-z) mesh for visualization of a climb route. MESH calls DRONE (discussed below) to test whether the climbing route is still on the side of the mountain mesh viewed by the user in the GUI window.

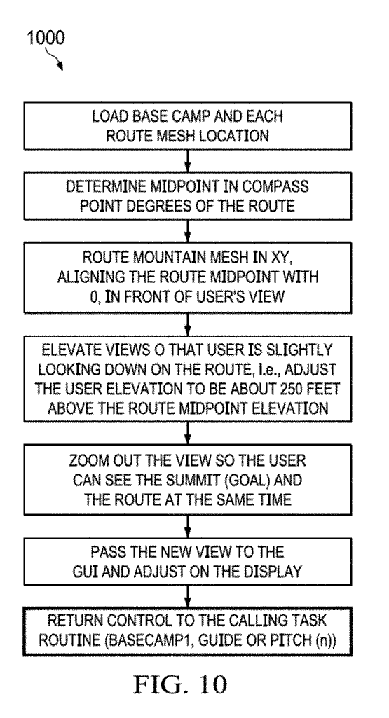

FIG. 10 illustrates a workflow diagram 1000 showing an example of the DRONE routine, according to this disclosure.

The DRONE routine helps to assure that the GUI delivers a usable view of the mountain mesh and the superimposed climbing route. DRONE includes a mesh rotation algorithm to bring the portfolio locations into the user plan view if the path moves behind the mountain in the plan view. Refer to FIG. 1 to understand the plan view of the mountain and route that are displayed in the GUI. DRONE rotates this view as required to center the route on the mountain visual for the user. An overhead view of the mountain can alternatively be delivered to the GUI window, as shown in FIGS. 9A-B. It does not rotate with user plan view.

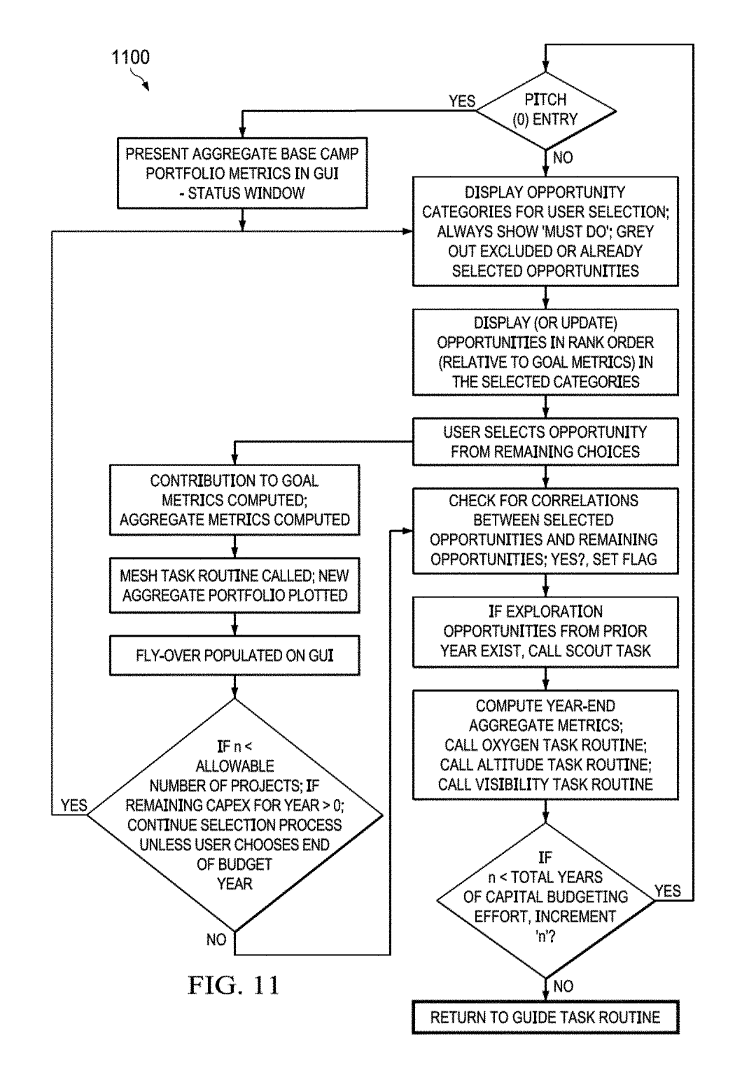

FIG. 11 illustrates a workflow diagram 1100 showing an example of the PITCH (n) routine, according to this disclosure.

The PITCH (n) routine updates the aggregate portfolio parameters (e.g., production, CAPEX, OPEX, net revenue, reserve movements, risk metric, etc.) for each selected opportunity. In PITCH (n), the number ‘n’ is defined by the number of capital budgeting years being evaluated. PITCH (n) uses the aggregate portfolio parameters to compute the new portfolio's location on the mountain mesh. This, in turn, is passed to MESH for display.

PITCH (n) is interactive with the user. PITCH (n) populates a fly-over pop-up on the mountain graphic. The fly-over shows the project opportunity added for that portion of the route, its key metrics, and how the project contributes to achieving the summit (e.g., the company's goal). If the user does not like the effect that a selected opportunity makes on the portfolio and the route up the mountain, PITCH (n) allows user to de-select the opportunity and choose another before locking in the annual budget. It does this by offering the user an ACCEPT or REJECT button before the user selects another opportunity during the capital budgeting year. The user is not locked in by this selection since changes can be made at later times during the climb. An end-of-budget-year button is available to the user to complete and exit the PITCH (n) budget cycle year task.

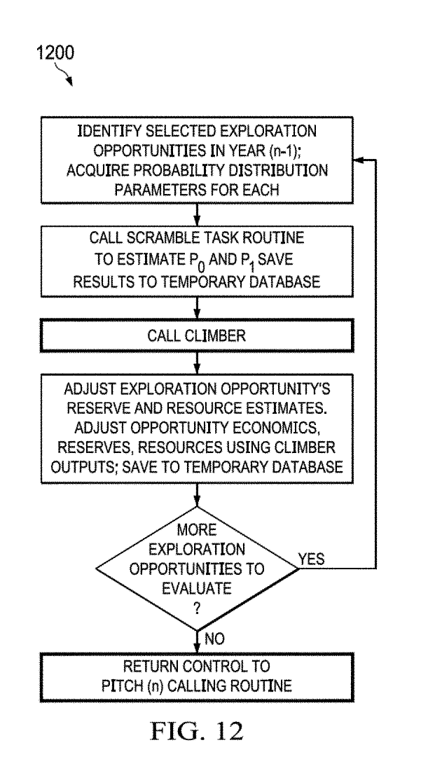

FIG. 12 illustrates a workflow diagram 1200 showing an example of the SCOUT routine, according to this disclosure.

The SCOUT routine tracks funded exploration projects and converts them to development investment opportunities in the opportunity inventory if there is a discovery and the discovery is commercial, i.e., its NPV is greater than zero. These estimates are made using probabilistic parameters of the key exploration variables computed in the SCRAMBLE routine (discussed below) using the Monte Carlo engine. The estimates are only computed if the exploration investment opportunity is chosen in a prior budget year cycle.

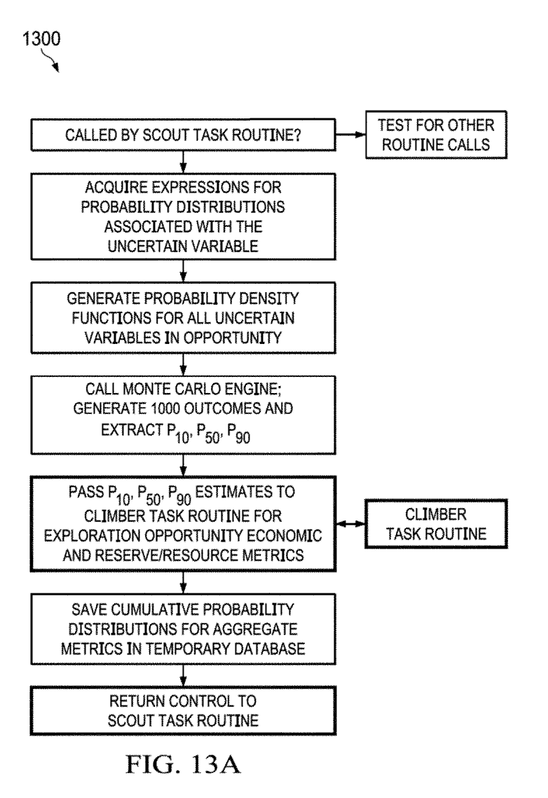

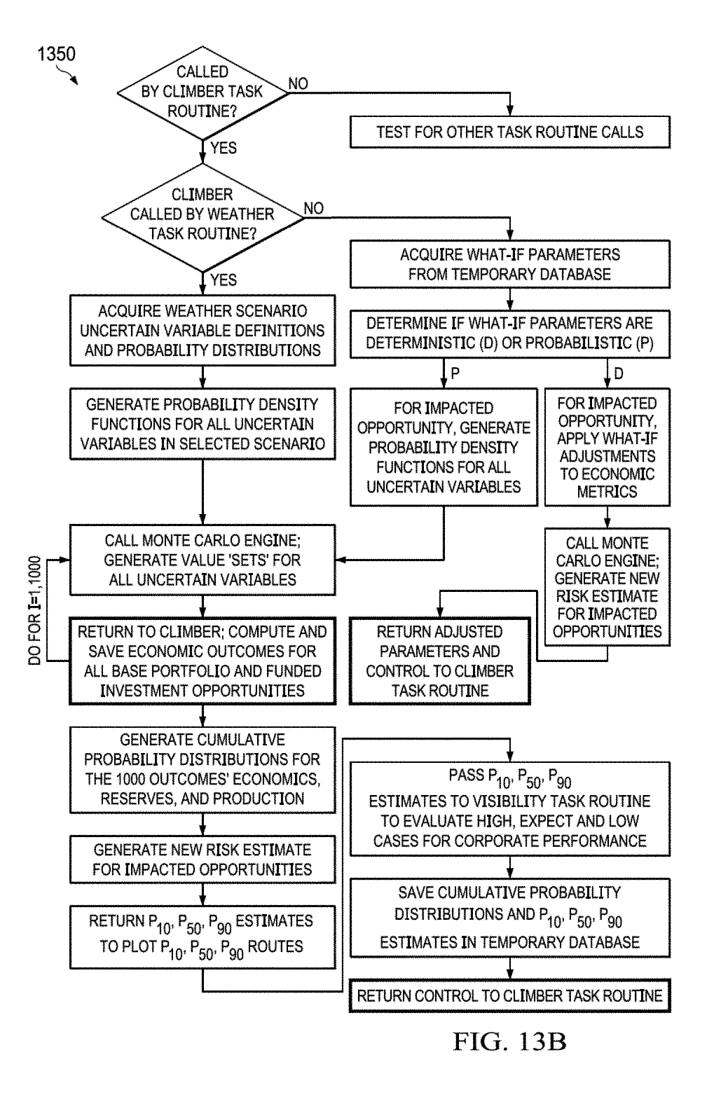

FIG. 13A illustrates a workflow diagram 1300 showing an example of the SCRAMBLE routine when called by SCOUT, according to this disclosure. FIG. 13B illustrates a workflow diagram 1350 showing an example of the SCRAMBLE routine when called by CLIMBER, according to this disclosure.

SCRAMBLE includes a Monte Carlo engine with several user-selectable probability distribution algorithms and a random number generator to pull values from the distributions of uncertain variable values used in CLIMBER (discussed below). The uncertain variable distributions and their parameters are loaded through KNAPSACK. Both uncertain economic variable parameters and exploration success parameters are used in SCRAMBLE, depending upon the calling task.

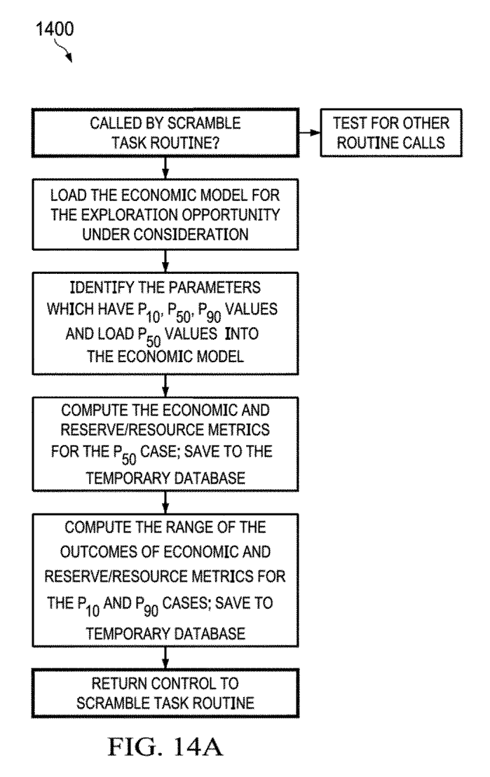

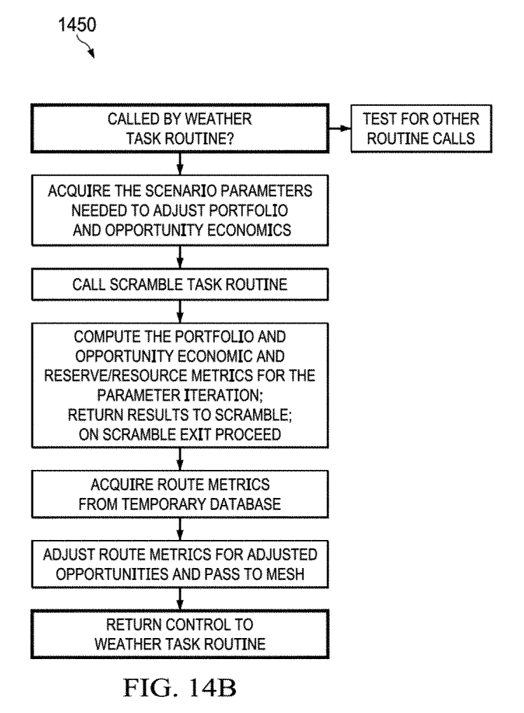

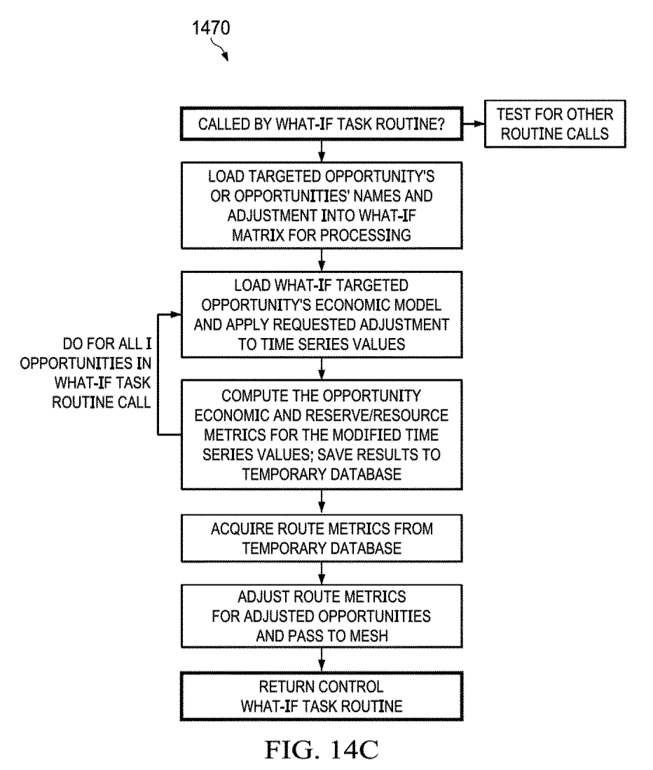

FIG. 14A illustrates a workflow diagram 1400 showing an example of the CLIMBER routine when called by SCRAMBLE, according to this disclosure. FIG. 14B illustrates a workflow diagram 1450 showing an example of the CLIMBER routine when called by WEATHER (discussed below), according to this disclosure. FIG. 14C illustrates a workflow diagram 1470 showing an example of the CLIMBER routine when called by WHAT-IF (discussed below), according to this disclosure.

CLIMBER is the application's internal economics engine. It adjusts the economic models provided by the user's economic application (PEEP, ARIES, OGRE, etc.) to estimate minor adjustments to costs, commodity prices, inflation, etc. When called by SCOUT, via SCRAMBLE, CLIMBER generates the P50 economics of an exploration opportunity. When called by WHAT-IF, CLIMBER estimates deterministic economic metrics for one or more opportunities associated with user-initiated events. CLIMBER estimates changes in deterministic metrics due to macroeconomic events, via the WEATHER task, as shown in FIG. 14B.

CLIMBER can compute probabilistic economic metrics that are used for estimating probability of success, risk and upside potential for each opportunity in the portfolio. CLIMBER can also be called by the ACROPHOBIA routine (discussed below) to test the robustness of the opportunity selections and the resulting CAPEX portfolio. For an ACROPHOBIA call, CLIMBER returns P10-P50-P90 distribution values of the portfolio metrics. For probabilistic calculations, CLIMBER calls SCRAMBLE, which uses the Monte Carlo engine to generate values for the uncertain variables.

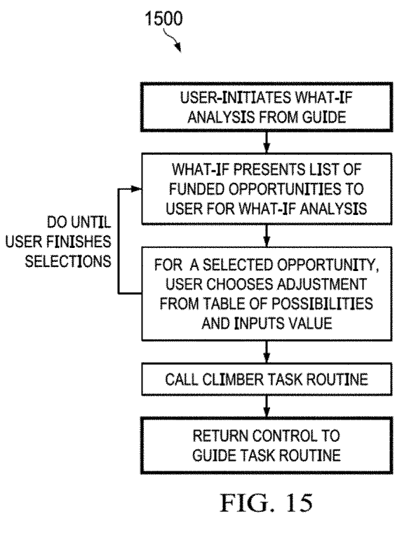

FIG. 15 illustrates a workflow diagram 1500 showing an example of the WHAT-IF routine, according to this disclosure.

The WHAT-IF routine allows the user to answer senior management questions about adjusting an individual opportunity's characteristics, i.e., timing, scope, etc. WHAT-IF may also be used to test the effects of a portfolio wide event that is not comprehended in the scenario set.

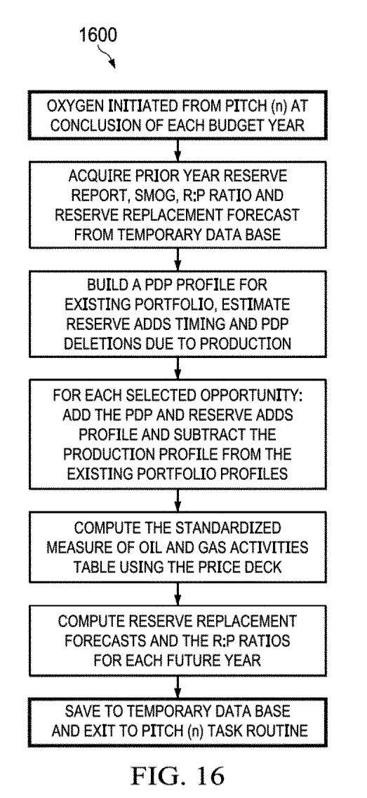

FIG. 16 illustrates a workflow diagram 1600 showing an example of the OXYGEN routine, according to this disclosure.

OXYGEN is the application's reserve and resource movements tracking algorithm. It is driven by initial user inputs, project selections, and capital allocated during the budget cycles under consideration. OXYGEN is called by PITCH (n) at the conclusion of each year of the budget cycle to compute the annual reserve replacement metric. OXYGEN uses inputs from the application database and from BASE CAMP 1. OXYGEN is used in the corporate metrics task, ALTITUDE (discussed below), to estimate the standardized measure of oil and gas assets (SMOG), as defined by the SEC, and estimate the market capitalization metric. In some embodiments, OXYGEN integrates standard regulatory (e.g., SEC) guidelines for recognizing the transfer of resources into reserves which are then available for production.

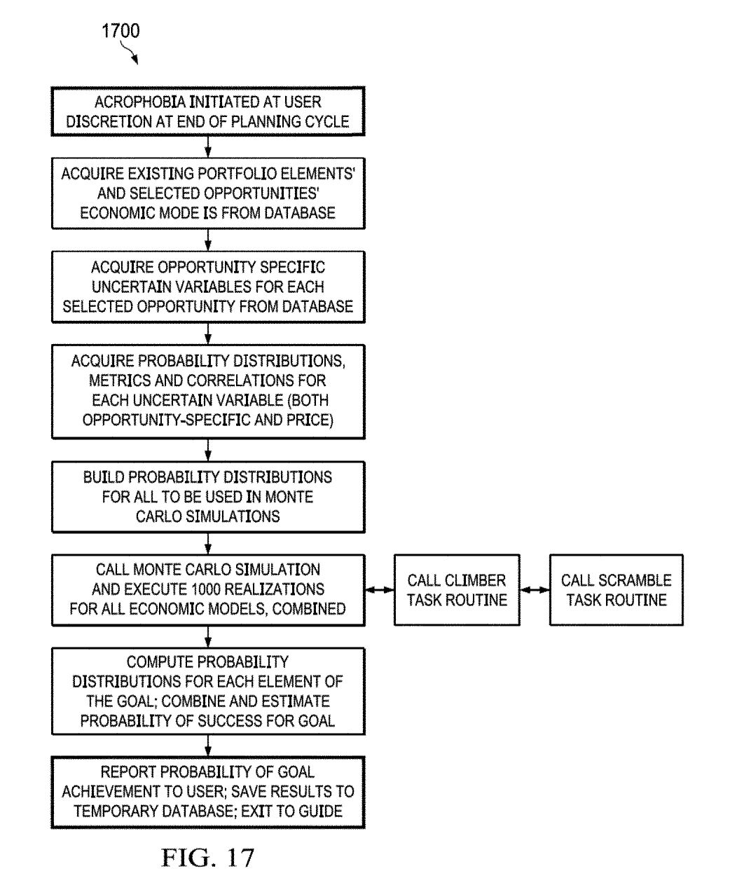

FIG. 17 illustrates a workflow diagram 1700 showing an example of the ACROPHOBIA routine, according to this disclosure.

ACROPHOBIA uses risk metrics from the base portfolio and the selected opportunities to test for portfolio robustness. The risk metrics are combinations of price uncertainty, reserves uncertainty, and execution timing uncertainty for each selected opportunity and the base portfolio. The result of the ACROPHOBIA routine is a measure of the probability of achieving the goal with this combination of opportunities. ACROPHOBIA is automatically called at the conclusion of the last budget cycle year. It can be called by the user at the conclusion of any intermediate budget cycle year but it uses the base portfolio, the selected opportunities, and selected subsets of the remaining opportunities in the inventory. ACROPHOBIA calls the CLIMBER and the SCRAMBLE routines to combine the uncertainties of the portfolio elements.

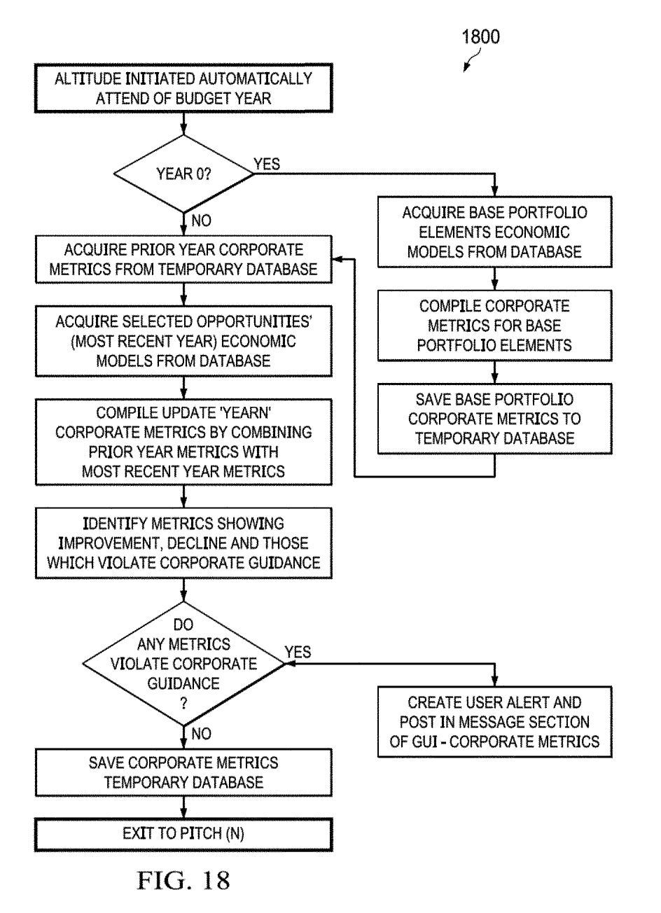

FIG. 18 illustrates a workflow diagram 1800 showing an example of the ALTITUDE routine, according to this disclosure.

ALTITUDE updates the corporate metrics at end of year, incorporating the new opportunities selected and the depletion of the existing (prior year) portfolio. ALTITUDE is automatically called when the user chooses the end of budget year button in PITCH. Outputs from ALTITUDE are provided to VISIBILITY (discussed below) and to a temporary storage portion of the database.

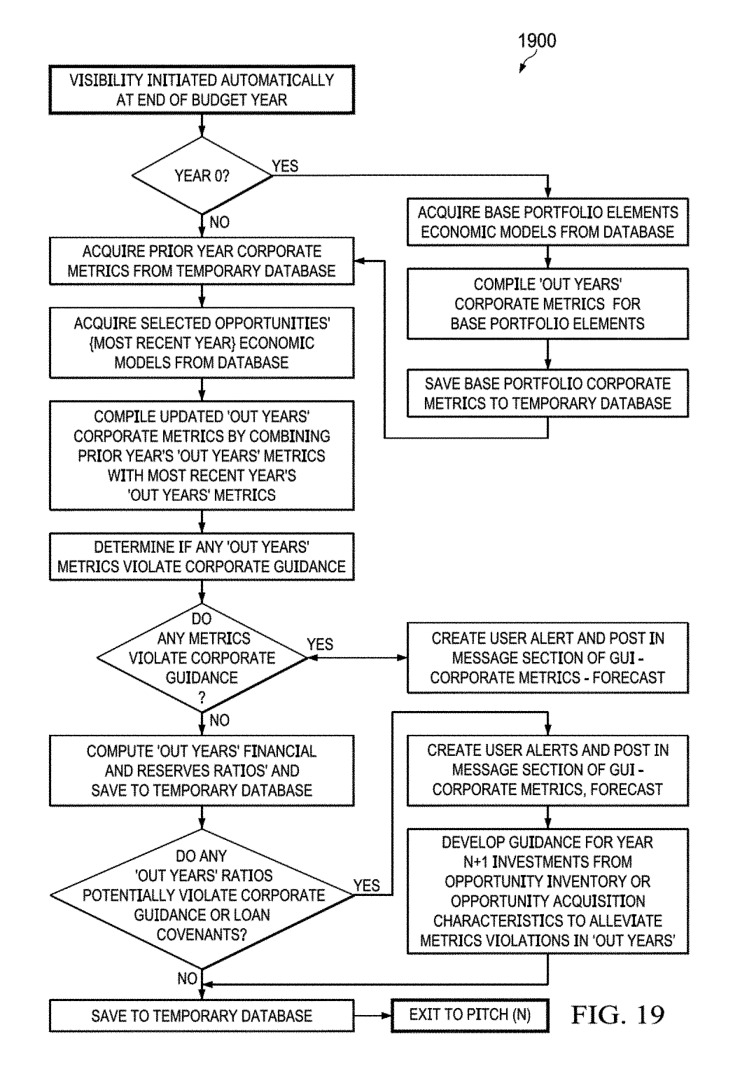

FIG. 19 illustrates a workflow diagram 1900 showing an example of the VISIBILITY routine, according to this disclosure.

VISIBILITY is the GUI window driver for user inspection of corporate performance. VISIBILITY manages and updates the corporate performance window of the GUI for future performance forecasting. It contains algorithms to compute business metrics relevant to the valuation of the enterprise. VISIBILITY computes performance status relative to corporate requirements and generates alerts when metrics go out of bounds.

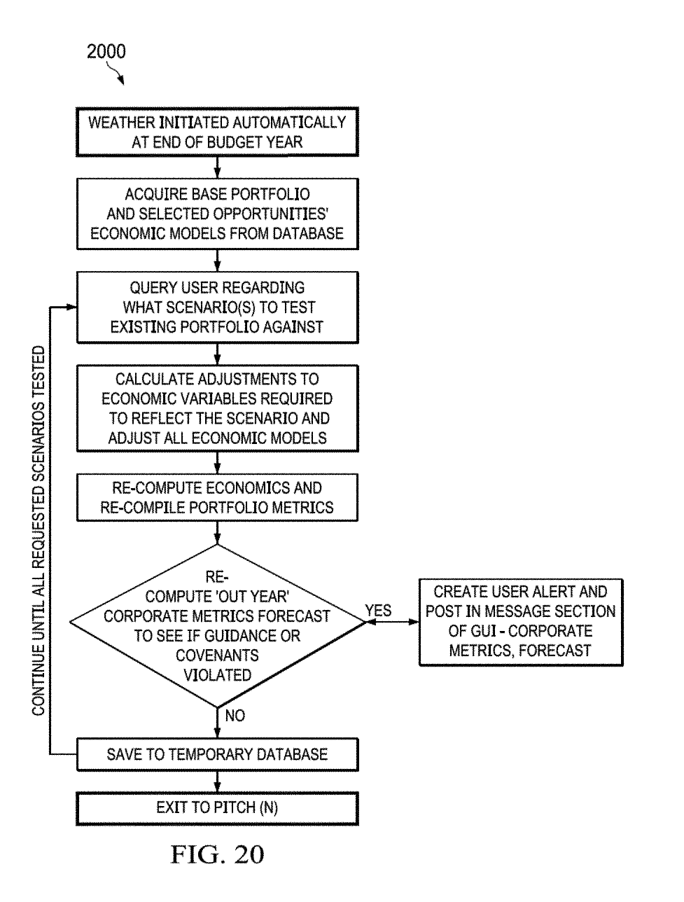

FIG. 20 illustrates a workflow diagram 2000 showing an example of the WEATHER routine, according to this disclosure.

WEATHER is a user-initiated routine that evaluates the performance of the portfolio during the climb as a function of changing macroeconomic conditions, i.e., scenarios. Named scenarios are loaded by the user using the KNAPSACK routine at the beginning of the analysis. WEATHER generates outputs for ALTITUDE and MESH and ultimately to the corporate performance window of the GUI through VISIBILITY.

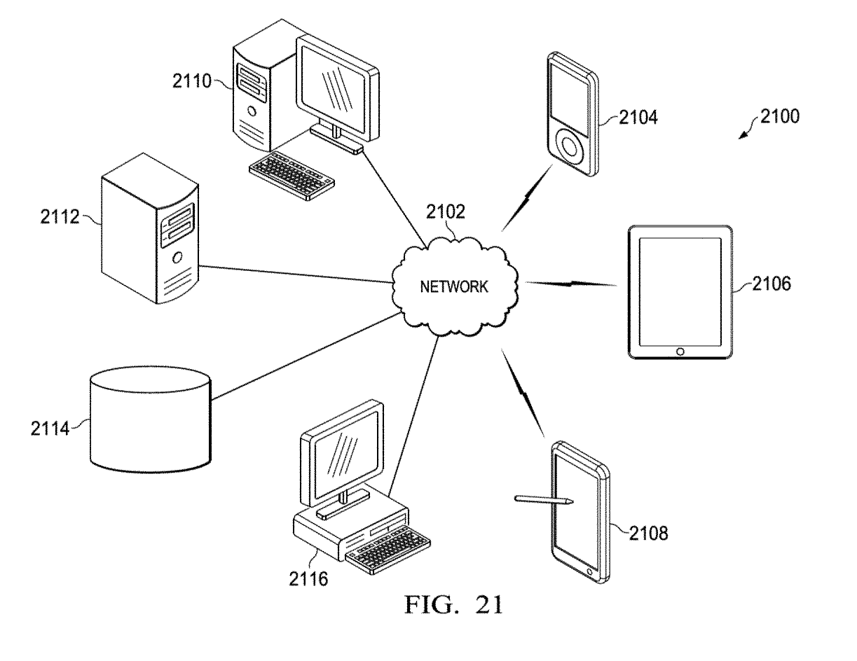

FIG. 21 illustrates an example system 2100 for planning and allocating capital, according to this disclosure. The embodiment illustrated in FIG. 21 is for illustration only. Other embodiments could be used without departing from the scope of this disclosure.

As shown in FIG. 21, the system 2100 includes a network 2102. The network 2102 generally represents a communication network or combination of communication networks facilitating communication between different devices or systems. Each network 2102 provides any suitable communication links, such as wired, wireless, fiber optic links, or the like. In particular embodiments, the network 2102 includes a combination of networks, such as the Internet, one or more cellular communication networks, and one or more local or wide area networks (which could support wired or wireless communications).

Multiple end user devices 2104-2110 communicate via the network 2102. The user devices 2104-2110 generally denote devices used for planning and allocating capital as described in greater detail herein. In particular, the user devices 2104-2110 can be configured to execute one or more applications for planning and allocating capital as described in greater detail herein. The user devices 2104-2110 include fixed or mobile devices that communicate over wired, wireless, or other connections with at least one of the networks 2102.

In this example, the user devices 2104-2110 include a personal digital assistant 2104, a smartphone 2106, a tablet computer 2108, and a desktop or laptop computer 2110. Any other or additional user devices can be used in the system 2100, and the system 2100 can support interaction with any number of user devices.

One or more servers 2112 also communicate over the network 2102. Each server 2112 represents a computing device that processes information associated with planning and allocating capital. Information associated with the operations of the server 2112 is stored in one or more related databases 2114, such as database(s) for planning and allocating capital as described in greater detail herein. For example, each server 2112 receives, updates, or processes information associated with planning and allocating capital. Different information or additional information can also be provided by each server 2112. Each server 2112 includes any suitable structure for providing information and interacting with user devices. The database 2114 includes any suitable structure for storing information and for facilitating retrieval of information.

One or more operator stations 2116 operated by users are capable of simultaneously interacting with the server 2112 and all other users. Operator stations and their users see selections, effects of constraints and goal progress of all other users. For example, an operator station 2116 allows an operator to make, receive, process, review, or interpret information associated with planning and allocating capital as described in greater detail herein. Each operator station 2116 includes any suitable structure supporting interaction with a server, such as a desktop computer, laptop computer, dumb terminal, or mobile device.

As described herein, each user device 2104-2110 and operator station 2116 executes an application or accesses an application executed by the server 2112. The application allows a user to interact with, receive information from, and provide information to, the server 2112. Thus, multiple users can collaborate in the project selection process, arriving at an acceptable solution more quickly. For example, the server 2112 can receive requests from the user devices 2104-2110 or operator station 2116 and, in response to receiving requests from the user devices 2104-2110 or operator station 2116, provides information from the database 2114. Other operations supported by the application are described herein.

Although FIG. 21 illustrates one example of a system 2100 for planning and allocating capital, various changes may be made to FIG. 21. For example, various components in FIG. 21 could be combined, further subdivided, rearranged, or omitted and additional components could be added according to particular needs. In addition, the display and manipulation of the mountain display analogy and data inputs and outputs may be available on a myriad of devices, such as tablets, mobile phones, desktop displays and panel screens. Other devices may include wearable devices such as active electronic goggles, glasses, pressure-activated gloves or jackets.

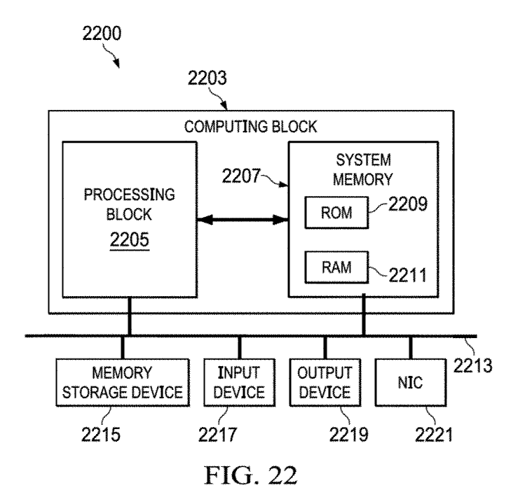

FIG. 22 illustrates an example of a computing device 2200 for planning and allocating capital, according to this disclosure. The computing device 2200 can be used in the system 2100. For example, the computing device 2200 can represent any of the components 2104-2112 and 2116 in FIG. 21. In general, the methods disclosed herein may be performed using a parallel computing platform comprising a plurality of computing nodes, such as a data center that includes multiple servers connected by a network. Each computing node may be represented by one computing device 2200. The parallel computing platform may have as few or as many computing nodes (e.g., computing devices 2200) as needed to perform the disclosed methods.

As shown in FIG. 22, the computing device 2200 includes a computing block 2203 with a processing block 2205 and a system memory 2207. The processing block 2205 may be any type of programmable electronic device for executing software instructions, but will conventionally be one or more microprocessors. The system memory 2207 may include both a read-only memory (ROM) 2209 and a random access memory (RAM) 2211. As will be appreciated by those of skill in the art, both the read-only memory 2209 and the random access memory 2211 may store software instructions for execution by the processing block 2205.

The processing block 2205 and the system memory 2207 are connected, either directly or indirectly, through a bus 2213 or alternate communication structure, to one or more peripheral devices. For example, the processing block 2205 or the system memory 2207 may be directly or indirectly connected to one or more additional memory storage devices 2215. The memory storage devices 2215 may include, for example, a “hard” magnetic disk drive, a solid state disk drive, an optical disk drive, and a removable disk drive. The processing block 2205 and the system memory 2207 also may be directly or indirectly connected to one or more input devices 2217 and one or more output devices 2219. The input devices 2217 may include, for example, a keyboard, a pointing device (such as a mouse, touchpad, stylus, trackball, or joystick), a touch screen, a scanner, a camera, and a microphone. The output devices 2219 may include, for example, a display device, a printer and speakers. Such a display device may be configured to display video images. With various examples of the computing device 2200, one or more of the peripheral devices 2215-2219 may be internally housed with the computing block 2203. Alternately, one or more of the peripheral devices 2215-2219 may be external to the housing for the computing block 2203 and connected to the bus 2213 through, for example, a Universal Serial Bus (USB) connection or a digital visual interface (DVI) connection.

With some implementations, the computing block 2203 may also be directly or indirectly connected to one or more network interfaces cards (NIC) 2221, for communicating with other devices making up a network. The network interface cards 2221 translate data and control signals from the computing block 2203 into network messages according to one or more communication protocols, such as the transmission control protocol (TCP) and the Internet protocol (IP). Also, the network interface cards 2221 may employ any suitable connection agent for connecting to a network, including, for example, a wireless transceiver, a modem, or an Ethernet connection.

It should be appreciated that the computing device 2200 is illustrated as an example only, and it not intended to be limiting. Various embodiments of this disclosure may be implemented using one or more computing devices that include the components of the computing device 2200 illustrated in FIG. 22, or which include an alternate combination of components, including components that are not shown in FIG. 22. For example, various embodiments may be implemented using a multi-processor computer, a plurality of single and/or multiprocessor computers arranged into a network, or some combination of both.

In some embodiments, various functions described above are implemented or supported by a computer program that is formed from computer readable program code and that is embodied in a computer readable medium. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

It may be advantageous to set forth definitions of certain words and phrases used throughout this patent document. The terms “application” and “program” refer to one or more computer programs, software components, sets of instructions, procedures, functions, objects, classes, instances, related data, or a portion thereof adapted for implementation in a suitable computer code (including source code, object code, or executable code). The terms “transmit” and “receive,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, have a relationship to or with, or the like. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

The description in the present application should not be read as implying that any particular element, step, or function is an essential or critical element that must be included in the claim scope. The scope of patented subject matter is defined only by the allowed claims. Moreover, none of the claims is intended to invoke 35 U.S.C. § 112(f) with respect to any of the appended claims or claim elements unless the exact words “means for” or “step for” are explicitly used in the particular claim, followed by a participle phrase identifying a function. Use of terms such as (but not limited to) “mechanism,” “module,” “device,” “unit,” “component,” “element,” “member,” “apparatus,” “machine,” “system,” “processor,” or “controller” within a claim is understood and intended to refer to structures known to those skilled in the relevant art, as further modified or enhanced by the features of the claims themselves, and is not intended to invoke 35 U.S.C. § 112(f).

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

What is claimed is:

1. A method comprising:
receiving an indication of a company goal representing a multi-year financial goal;
determining multiple feasible capital projects for achieving the company goal, the multiple feasible capital projects based on a set of investment opportunity and planning scenarios;
receiving a user selection of multiple capital projects among the multiple feasible capital projects;
determining at least one route for each of the selected capital projects, wherein each route indicates a contribution, by the selected capital project, of progress toward the company goal; and
generating a graphical display showing a mountain, wherein the company goal is visually represented as a summit of the mountain and the routes are visually represented on one or more sides of the mountain.

2. The method of claim 1, further comprising:
determining a base camp on the mountain based on a company's existing set of ongoing funded capital projects; and
updating the graphical display to show the base camp on the mountain.

3. The method of claim 1, further comprising:
receiving user updates to one or more of the selected capital projects;
determining a change to the corresponding routes based on the user updates, the change associated with an effect on the company goal; and
updating the graphical display to show the changed routes on the mountain.

4. The method of claim 1, wherein the routes progress from a lower valley on the mountain to the summit.

5. The method of claim 1, wherein a steepness of each route on the mountain is displayed according to a riskiness of the corresponding project with respect to achieving target metrics of the corresponding project, wherein the riskiness of the corresponding project is associated with uncertain future external events.

6. The method of claim 1, wherein an elevation gain of each route on the mountain is displayed according to a percentage gain of the corresponding project towards the company goal.

7. The method of claim 1, wherein receiving the user selection of multiple capital projects comprises:
receiving selections in real-time from multiple users associated with multiple user devices, wherein the multiple user devices share information about the selected projects over a network.

8. The method of claim 1, wherein the mountain is graphically represented as a three-dimensional mesh.

9. The method of claim 1, wherein the selected capital projects comprise:
first capital projects selected for Year 1; and
second capital projects selected for Years 2 through N, as determined by user needs,
wherein the first capital projects and the Years 2 through N capital projects are incremental to an existing project portfolio.

10. A system comprising:
at least one memory; and
at least one processor coupled to the at least one memory, the at least one processor configured to:
receive an indication of a company goal representing a multi-year financial goal;
determine multiple feasible capital projects for achieving the company goal, the multiple feasible capital projects based on a set of investment opportunity and planning scenarios;
receive a user selection of multiple capital projects among the multiple feasible capital projects;
determine at least one route for each of the selected capital projects, wherein each route indicates a contribution, by the selected capital project, of progress toward the company goal; and
generate a graphical display showing a mountain, wherein the company goal is visually represented as a summit of the mountain and the routes are visually represented on one or more sides of the mountain.

11. The system of claim 10, wherein the at least one processor is further configured to:
determine a base camp on the mountain based on a company's existing set of ongoing funded capital projects; and
update the graphical display to show the base camp on the mountain.

12. The system of claim 10, wherein the at least one processor is further configured to:
receive user updates to one or more of the selected capital projects;
determine a change to the corresponding routes based on the user updates, the change associated with an effect on the company goal; and
update the graphical display to show the changed routes on the mountain.

13. The system of claim 10, wherein the routes progress from a lower valley on the mountain to the summit.

14. The system of claim 10, wherein a steepness of each route on the mountain is displayed according to a riskiness of the corresponding project with respect to achieving target metrics of the corresponding project, wherein the riskiness of the corresponding project is associated with uncertain future external events.

15. The system of claim 10, wherein an elevation gain of each route on the mountain is displayed according to a percentage gain of the corresponding project towards the company goal.

16. The system of claim 10, wherein to receive the user selection of multiple capital projects, the at least one processor is configured to:
receive selections in real-time from multiple users associated with multiple user devices, wherein the multiple user devices share information about the selected projects over a network.

17. The system of claim 10, wherein the mountain is graphically represented as a three-dimensional mesh.

18. The system of claim 10, wherein the selected capital projects comprise:
first capital projects selected for Year 1; and
second capital projects selected for Years 2 through N, as determined by user needs,
wherein the first capital projects and the Years 2 through N capital projects are incremental to an existing project portfolio.

19. A non-transitory computer readable medium containing instructions that when executed cause at least one processing device to:
receive an indication of a company goal representing a multi-year financial goal;
determine multiple feasible capital projects for achieving the company goal, the multiple feasible capital projects based on a set of investment opportunity and planning scenarios;
receive a user selection of multiple capital projects among the multiple feasible capital projects;
determine at least one route for each of the selected capital projects, wherein each route indicates a contribution, by the selected capital project, of progress toward the company goal; and
generate a graphical display showing a mountain, wherein the company goal is visually represented as a summit of the mountain and the routes are visually represented on one or more sides of the mountain.

20. The non-transitory computer readable medium of claim 19, further comprising instructions that when executed cause the at least one processing device to:
determine a base camp on the mountain based on a company's existing set of ongoing funded capital projects; and
update the graphical display to show the base camp on the mountain.
